(19) United States
(12) Patent Application Publication
(10) Pub. No.: US 2007/0171578 A1
(43) Pub. Date: Jul. 26, 2007

(54) Head stack assembly, manufacturing method thereof, and disk drive unit

(75) Inventors: Takehiro Kamigama, Hong Kong (CN); Masahiko Fujioka, Hong Kong (CN); YiuSing Ho, Hong Kong (CN); Hiroshi Fukaya, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics(H.K.) Ltd, Hong Kong (CN)

(21) Appl. No.: 11/394,205

(22) Filed: Mar. 31, 2006

(30) Foreign Application Priority Data
Jan. 26, 2006 (CN) 200610004634.X

(51) Int. Cl. G11B 5/55

(52) U.S. Cl. 360/264.1

(57) ABSTRACT

A HSA for a disk drive unit includes at least one drive arms, each of which has a mounting hole formed thereon; at least one HGAs, each of which connecting with one of the at least one drive arms; a fantail spacer having a mounting hole; and a bearing assembly; wherein the bearing assembly respectively extends through the mounting holes of the at least one drive arms and the fantail spacer and fastens them together; wherein each of the drive arms has at least one first positioning elements, and the fantail spacer has at least one second positioning elements each of which engaging with one of the first positioning elements. Also disclosed is a manufacturing method of the HSA.

### FIELD OF THE INVENTION

The present invention relates to information recording devices and, more particularly, to a head stack assembly (HSA) for a disk drive unit and manufacturing method thereof.

### BACKGROUND OF THE INVENTION

A disk drive unit realizes data writing/reading by positioning a magnetic read/writing head on a rotary medium such as a disk. Referring to FIG. 1, a typical disk drive 100 comprises a disk 104 with a plurality of concentric tracks (not shown) formed thereon to record data information. The disk 104 is driven by a spindle motor 105 to rotate at a high speed. Also referring to FIG. 2, the disk drive 100 also comprises a head stack assembly (HSA) 200. The HSA 200 is driven by a voice coil motor (VCM) 103 mounted in the disk drive 100 to rotate, thus causing selective movement of a slider 101 and read/write transducer incorporated therein from track to track along the surface of the disk 104, thereby realizing writing data to or reading data from the disk 104.

Referring to FIGS. 2a-2b, the conventional HSA 200 includes a plurality of drive arms 202 each of which is connected to a suspension 201 at another end thereof, and a fantail spacer 204. The plurality of drive arms 202 are assembled together by a bearing assembly 206. A mounting hole 2022 is formed at one end of each drive arm 202. The slider 101 with read/write transducers (not shown) formed thereon for data reading/writing is supported by the suspension 201. The suspension 201 and slider 101 carried thereon are also known as a head gimbal assembly (HGA) (not shown), and combination assembly (HAA) 300. The fantail spacer 204 has a mounting hole 2042 formed therein corresponding to the mounting hole 2022 of each drive arm 202. The baring assembly 206 comprises a bearing 2062, a washer 2064 and a nut 2068, all of which operatively assemble the drive arms 202 to the fantail spacer 204.

The conventional HSA 200 described above is assembled as follows: first, one of the HAAs 300 is disposed on a top surface of the fantail spacer 204, and the mounting hole 2022 of the HAA 300 is aligned with the mounting hole 2042 of the fantail spacer 204; then another HAA 300 is disposed on bottom surface of the fantail spacer 204, making the mounting hole 2022 of the HAA 300 being aligned with the mounting hole 2042 of the fantail spacer 204; finally the bearing 2062 of the bearing assembly 206 passes through the mounting holes 2022, 2042, the washer 2064 passes through the bearing 2062 and is pressured against bottom surface of the HAA 300 that locates under the fantail spacer 204, and finally both upper and lower HAAs 300 and the fantail spacer 204 are assembled together as an entirety by the nut 2068; finally the HSA 200 is secured by a specific fixture and a performance test is performed to the slider 101.

However, in assembly process using the bearing assembly 206, since no effective temporary locating is applied to the HAA 300 and the fantail spacer 204, thus during fastening process using the nut 2068, a relative rotation may happen between the HAA 300 and the fantail spacer 204, thus causing the slider on the HAA 300 inaccurately positioned with respect to the fantail spacer 204. Accordingly, when the HSA 200 is driven by the VCM, a fine position adjustment of the slider above the disk is unable to be obtained, and this seriously affect data reading/writing operation of the slider on the disk. In addition, due to specific structure of the HSA 200 itself, it is difficult to secure the HSA 200 firmly to perform a performance test thereto even if a special fixture is used. Furthermore, in case when a slider is found defective, the HSA 200 had to be disassembled entirely to replace the defective slider, since slider performance test is performed after the HSA 200 has been assembled completely. This makes the assembly process low efficient, troublesome and time-consuming.

Thus, there is a need for to provide an improved HSA, disk drive unit incorporating the same and manufacturing method thereof that does not suffer from the above-mentioned drawbacks.

### SUMMARY OF THE INVENTION

One aspect of the present invention is to provide a HSA, the slider of which can be precisely positioned above the tracks of the disk surface, thus realizing fine data reading/writing operation.

Another aspect of the invention is to provide a manufacturing method of HSA that can effectively improve positional accuracy of the slider relative to the HSA.

Another aspect of the invention is to provide a manufacturing method of HSA that greatly facilitates slider performance testing, improves work efficiency and reduces cost.

To achieve above purposes, the invention provides a HSA for a disk drive unit which comprises: at least one drive arms, each of which has a mounting hole formed thereon; at least one HGAs, each of which connecting with one of the at least one drive arms; a fantail spacer having a mounting hole; and a bearing assembly; wherein the bearing assembly respectively extends through the mounting holes of the at least one drive arms and the fantail spacer and fastens them together; wherein each of the drive arms has at least one first positioning elements, and the fantail spacer has at least one second positioning elements each of which engaging with one of the first positioning elements.

In one embodiment of the invention, the first positioning elements and the second positioning elements are secured together by laser welding. In another embodiment of the invention, the first positioning elements and second positioning elements are secured together by bonding or clasping.

In one embodiment of the invention, the first positioning elements are positioning holes, the second positioning elements are positioning posts disposed on the fantail spacer, and the positioning posts extend through respective positioning holes and are secured thereto. Preferably, each of the drive arms has two first positioning elements, the two first positioning elements being in a same line with the center of the mounting hole of the drive arm; and the second positioning elements of the fantail spacer has an amount adapted to that of the first positioning elements. The first positioning elements and the second positioning elements are made of metal material, such as stainless steel material. In one embodiment of the invention, the positioning holes are of circle shape, and the positioning posts are of cylinder shape.

A disk drive unit of the invention comprises: a disk; a spindle motor to spin the disk; a HSA; and a voice coil motor to cause movement of the HSA. at least one drive arms, each of which has a mounting hole formed thereon; at least one HGAs, each of which connecting with one of the at least one drive arms; a fantail spacer having a mounting hole; and a bearing assembly; wherein the bearing assembly respectively extends through the mounting holes of the at least one drive arms and the fantail spacer and fastens them together; wherein each of the drive arms has at least one first positioning elements, and the fantail spacer has at least one second positioning elements each of which engaging with one of the first positioning elements.

A manufacturing method of HSA according to an embodiment of the invention comprises the steps of: 1) providing at least one drive arms, each of which having a mounting hole and at least a first positioning elements; at least one HGAs; a fantail spacer having a mounting hole and at least one second positioning elements engaging with the at least one first positioning elements, respectively; and a bearing assembly; 2) assembling the at least one drive arms and the at least one HGAs to form at least one HAAs; 3) fastening the first and second positioning elements together such that the at least one HAAs and the fantail spacer are fastened together; and 4) fastening the at least one HAAs and the fantail spacer together stably by extending the bearing assembly through the respective mounting holes of the at least one HAAs and the fantail spacer.

A manufacturing method of HSA according to another embodiment of the invention comprises steps of: 1) providing at least one drive arms, each of which having a mounting hole and at least a first positioning elements; at least one HGAs, a fantail spacer having a mounting hole and at least one second positioning elements engaging with the at least one first positioning elements, respectively; and a bearing assembly; 2) assembling the at least one drive arms and the at least one HGAs to form at least one HAAs; 3) fastening the first and second positioning elements together such that the at least one HAAs and the fantail spacer are fastened together; 4) testing slider performance of the at least one HGAs; and 5) fastening the tested HAAs and the fantail spacer together stably by extending the bearing assembly through the respective mounting holes of the at least one HAAs and the fantail spacer.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2a is a perspective view of a HSA of the conventional disk drive unit shown in FIG. 1 in an assembled state;

FIG. 2b is an exploded perspective view of the HSA of the conventional disk drive unit shown in FIG. 1;

FIG. 3 is an exploded perspective view of a HSA after a bearing assembly thereof is removed according to an embodiment of the invention;

FIG. 4 is a perspective view of FIG. 3 in an assembled state;

FIG. 5 is an exploded perspective view of a HSA according to an embodiment of the invention;

FIG. 6 is a perspective view of FIG. 5 in an assembled state;

FIG. 7 shows a process flowchart illustrating a manufacturing method of HSA according to an embodiment of the invention;

FIG. 8 shows a process flowchart illustrating a manufacturing method of HSA according to another embodiment of the invention; and

FIG. 9 shows a perspective view of a disk drive unit according to one embodiment of the invention.

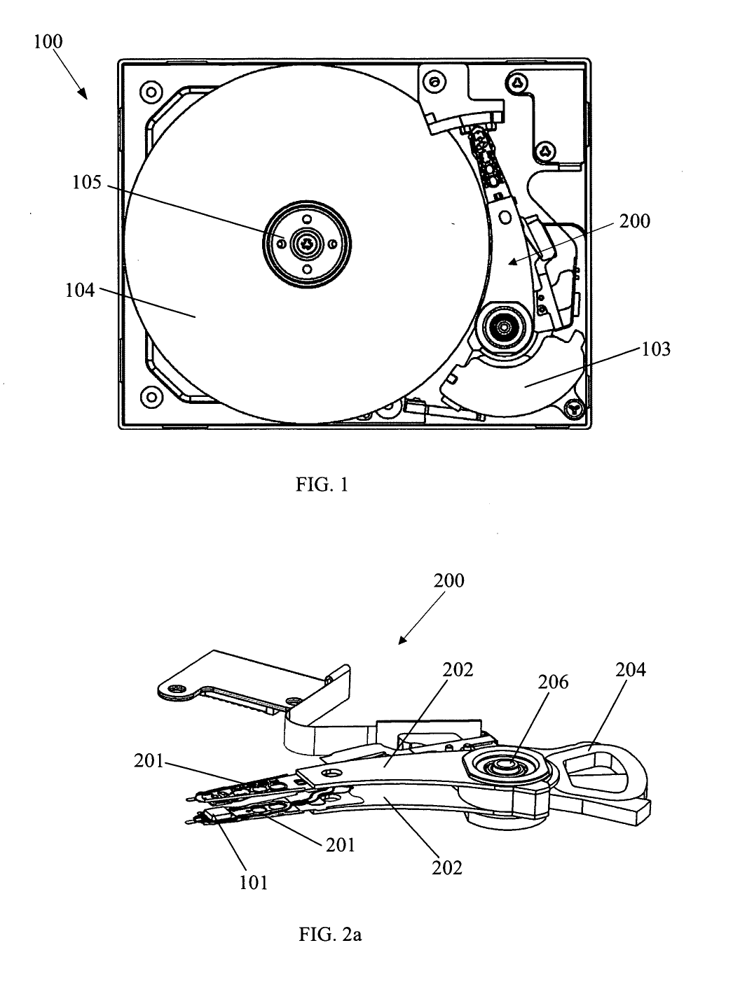

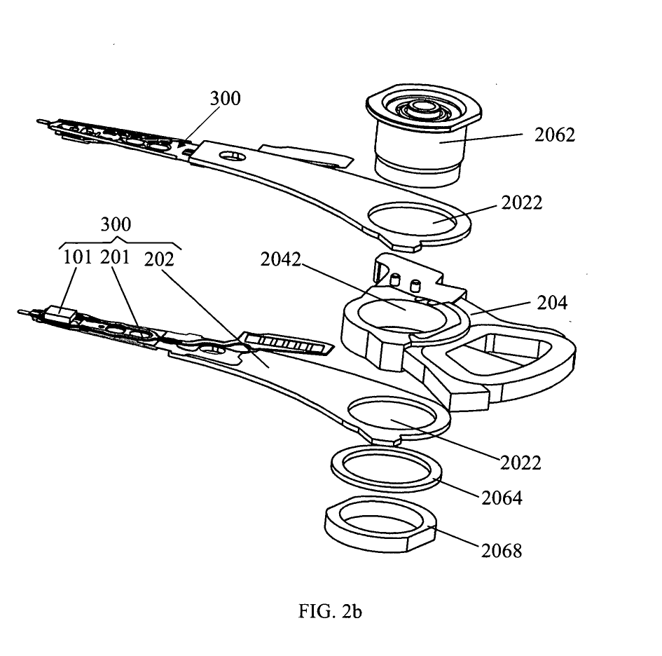

### DETAILED DESCRIPTION OF ILLUSTRATED EMBODIMENTS

Substance and various preferred embodiments of the instant invention will now be described. A HSA for a disk drive unit of the invention comprises at least one drive arms, each of which has a mounting hole formed thereon; at least one HGAs, each of which connecting with one of the at least one drive arms; a fantail spacer having a mounting hole; and a bearing assembly; wherein the bearing assembly respectively extends through the mounting holes of the at least one drive arms and the fantail spacer and fastens them together; wherein each of the drive arms has at least one first positioning elements, and the fantail spacer has at least one second positioning elements each of which engaging with one of the first positioning elements. In the invention, since existence of the first and second positioning elements, before fixation of the drive arm and the fantail spacer using the bearing assembly, the drive arm and fantail spacer may be temporarily secured each other in advance by engagement of the first and second positioning elements. Therefore, because the HGA and drive arm are also in a connected/fixed state (A HGA and a drive arm are assembled together to form a HAA), the HGA (the drive arm or HAA) will not rotate relative to the fantail spacer, and consequently, the HGA (the drive arm or head arm assembly) will also not rotate relative to the fantail spacer in process of coupling the drive arm with the fantail spacer and/or after they are coupled together. Thus, it is ensured that a slider on the HGA has a very accurate position with respect to the fantail spacer. Hence, when a VCM drives the HSA, the slider can be positioned accurately on the disk, thereby enabling correct data reading/writing on the disk.

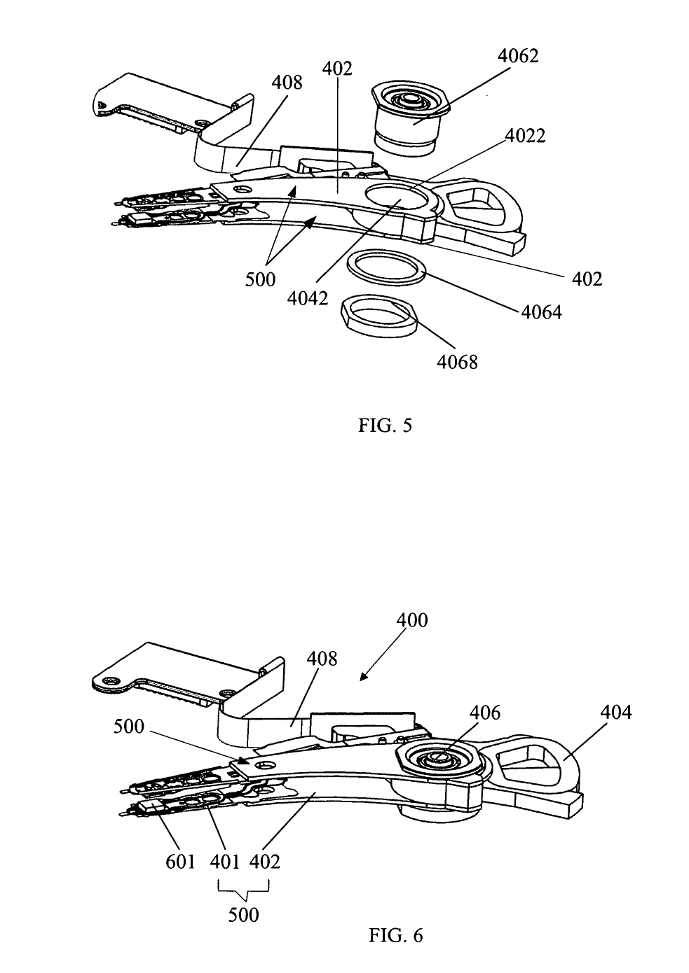

Several example embodiments of the invention will now be described. Referring to FIGS. 5-6, according to one embodiment of the invention, a HSA 400 comprises two HAAs 500, a fantail spacer 404 disposed between the HAAs 500 and a bearing assembly 406 for connecting the HAAs 500 to the fantail spacer 404. Each HAA 500 comprises a drive arm 402 and a HGA 401 connected to the drive arm 402. The head gimbal assembly 401 each has a slider 601 mounted thereon, and the slider 601 has a read/write transducer incorporated thereon to perform data reading/writing operation.

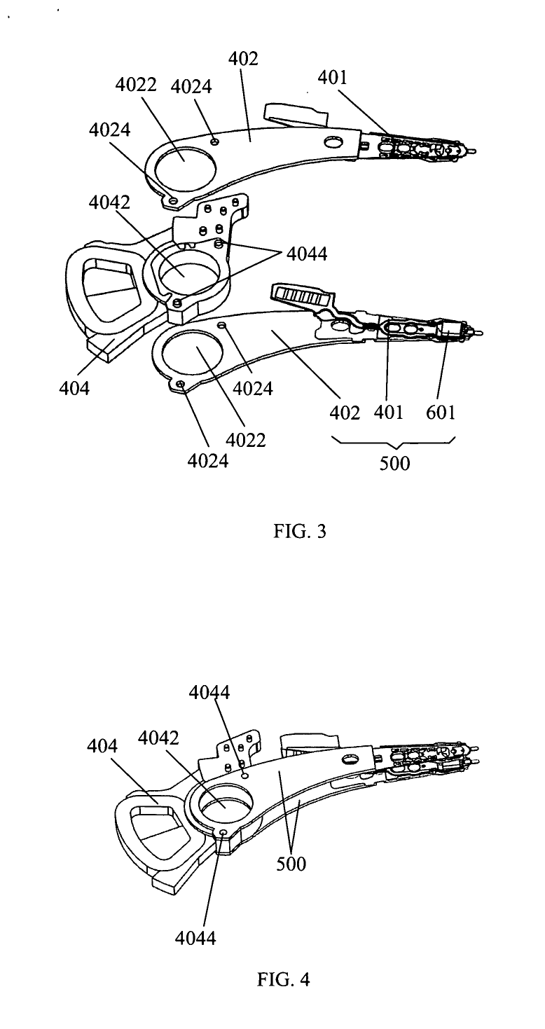

Referring to FIG. 3, the drive arm 402 has a mounting hole 4022 formed at one end thereof and two first positioning elements such as two circle positioning holes 4024 formed adjacent the mounting hole 4022. Contemporarily, the fantail spacer 404 has a mounting hole 4042 corresponding to the mounting hole 4022 of the drive arm 402. Corresponding to the first positioning elements of the two drive arms 402, a certain number (the same as that of the first positioning elements) of second positioning elements such as circle positioning posts 4044 extruded from the fantail spacer 404 are provided at both sides of the mounting hole 4042 thereof. The circle positioning post 4044 has proper diameter so as to pass through respective circle positioning hole 4024. In the invention, the positioning post 4044 and region of the drive arm 402 where the positioning hole 4024 is formed may be constructed of metal material e.g. stainless steel material. Referring to FIGS. 3-4, in assembly process, the two drive arms 402 are pressed against both sides of the fantail spacer 404 respectively, the mounting holes 4022 and 4042 being aligned each other, the positioning posts 4044 of the fantail spacer 404 extending across the two positioning holes 4024 of the drive arm 402 respectively. Then the positioning post is welded with respective positioning hole by laser welding, thus preventing rotation of each of the drive arms 402 with respect to the fantail spacer 404. In present invention, arrangement of circle-shaped positioning hole and cylindrical positioning post is for purpose of making engagement therebetween smoother.

Preferably, referring to FIG. 3, each of the drive arms 402 has two first positioning elements such as circle positioning holes 4024, and they are in a symmetric relationship about the center of the mounting hole 4022 of the drive arm 402. The second positioning elements such as circle positioning posts of the fantail spacer 404 have the same number as that of the first positioning elements. This configuration of the first and second positioning elements can avoiding relative rotation between the HGA 401 (the drive arm 402 or HAA 500) and the fantail spacer 404 more effectively.

In present invention, referring to FIGS. 5-6, the bearing assembly 406 includes a bearing 4062, a washer 4064 and a nut 4068. The bearing 4062 extends through the mounting holes 4022 of the drive arms 402 disposed at both sides of the fantail spacer 404 and the mounting hole 4042 of the fantail spacer 404 sandwiched between the two drive arms 402; the washer 4064 extends through the bearing 4062 and is pressed against a drive arm 402 that is positioned at a side of the fantail spacer 404; and the nut 4068 is secured at distal end of the bearing 4062, thereby the fantail spacer 404, the drive arms 402 provided on both sides of the fantail spacer 404 and the bearing assembly 406 being connected together securely. Referring to FIG. 5a, the HSA 400 may further include a flex printed circuit assembly 408 on the fantail spacer 404 thereof to control and drive a VCM (not shown). In addition, the fantail spacer 404 may also have a voice coil (not shown) that forms a part of the VCM.

It is noted that though in the embodiment, the number of the positioning holes 4024 formed on the drive arm 402 is two, the number may also be one, three or more according to actual requirement; correspondingly, the number of the positioning posts 4044 of the fantail spacer 404 depends on the number of the positioning holes. Furthermore, the positioning hole is not limited to in a circle shape, other suitable shapes, such as rectangular or ellipse shape may also be used as a shape of the positioning hole of the invention; and the positioning post is also not limited to in a cylinder shape, other suitable shapes, such as rectangular or ellipse shape may also be used as a shape of the positioning post of the invention.

Moreover, in present invention, the first positioning element is not limited to positioning hole, and the second positioning element is not limited to positioning post. Any suitable means that can realize engagement each other and temporary positioning may be applied to the first and second positioning elements of the invention. In the embodiment, the drive arm is made of metal material only at the region around the positioning holes thereof, thus enabling being welded with the positioning posts that are made of metal material and provided on the fantail spacer by laser welding. Understandably, the drive arm may also be constructed of metal material completely. Of course, the positioning post and positioning hole may also be engaged together by other manner, for example bonding or clasping, in case where the positioning post and region around the positioning hole are made of other suitable materials.

In the embodiment above, the HSA 400 comprises two HAAs 500. Understandably, the HSA of the invention may only have one HAA or four or even more HAAs.

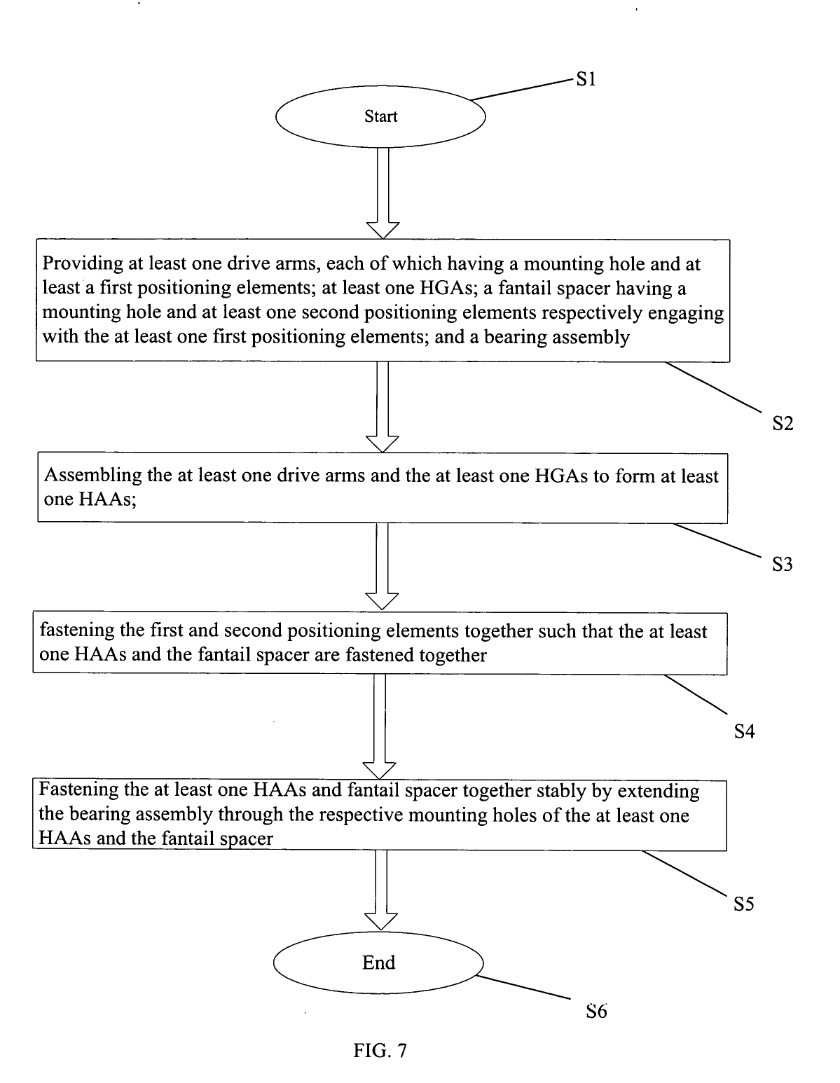

The following provides a manufacturing method of a HSA according to one embodiment of the invention. Referring now to FIG. 7, when the process starts (step S1 of FIG. 7); firstly, at least one drive arms, at least one HGAs, a fantail spacer and a bearing assembly are provided; each of the drive arm has a mounting hole and at least a first positioning elements thereon; the fantail spacer has a mounting hole and at least one second positioning elements thereon; the at least one second positioning elements engages with the at least one first positioning elements, respectively (step S2 of FIG. 7); then, the at least one drive arms and the at least one HGAs are assembled to form at least one HAAs (step S3 of FIG. 7); next, the first and second positioning elements are secured together such that the at least one HAAs and the fantail spacer are fastened together (step S4 of FIG. 7); finally the at least one HAAs and the fantail spacer are fastened together stably by extending the bearing assembly through the respective mounting holes of the at least one HAAs and the fantail spacer (step S5 of FIG. 7); and thus the process ends (step S6 of FIG. 7).

In the invention, since the at least one HAAs, such as two HAAs, and the fantail spacer are temporarily positioned effectively by engagement of the first and second positioning elements before they are assembled together by the bearing assembly, accordingly, during process of fastening the HAA and the fantail spacer using the bearing assembly, a relative rotation between the HAA and the fantail spacer is thus prevented, after assembly, the slider of the HAA has no position variation existed between itself and the fantail spacer, hence, when the HSA is driven by the VCM, the slider of the HSA can attain a fine position adjustment above the disk and performing a correct data reading/writing operation on the disk.

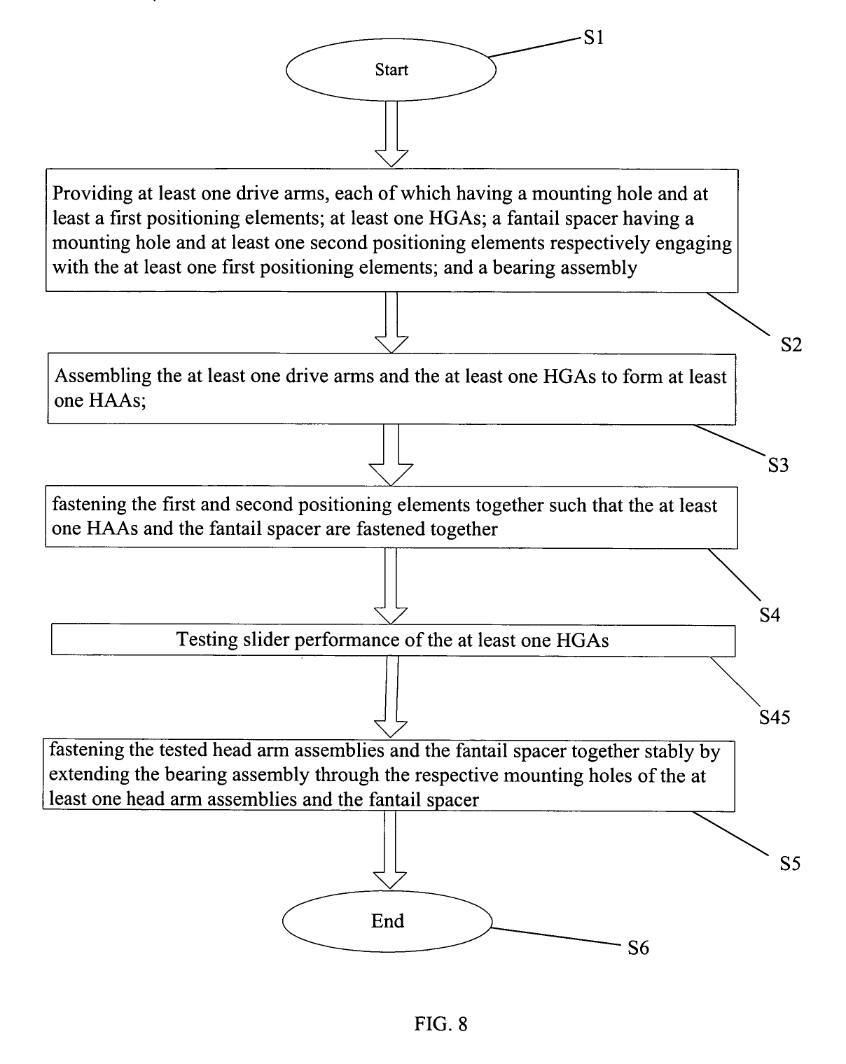

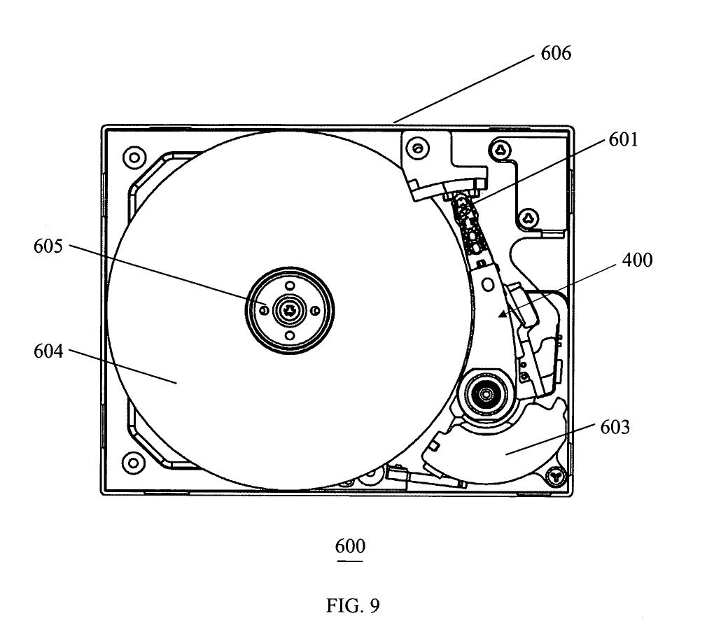

Referring to FIG. 8, in another embodiment of the invention, in addition to the steps shown in FIG. 7, a step S45 may also be included between the step S4 and step S5, that is, a step of performance test to the slider of the HGA. Since the step of slider performance testing is arranged before complete assembly of the HSA, consequently, when a slider is found defective, the slider may be replaced from only the HGA, and full disassembling of the HGA is avoidable, thus improving working efficiency greatly and reducing manufacturing cost.

In one embodiment of the invention, for testing the slider provided on the HGA conveniently, a fixture (not shown) is used which extends through the mounting holes of the at least one HAAs and the fantail spacer after they are secured together to hold the at least one HAAs and the fantail spacer. It is preferable that the fixture is adapted to the mounting holes of the at least one HAAs and the fantail spacer. As the fixture extends through the mounting holes of the at least one HAA and the fantail spacer, the at least one HAA and the fantail spacer are held firmly, thus overcoming a problem that the HAAs and the fantail spacer can not be held firmly using a specific fixture in prior art.

In the invention, regardless of specific structure of the first and second positioning elements, the manufacturing method or process thereof may be derived from the process described above, and description of various structures of the first and second positioning elements and derived methods thereof is omitted herefrom.

FIG. 8 illustrates a plan structural view of a disk drive unit incorporating the HSA 400 according to one embodiment of the invention. As illustrated, the disk drive unit 600 comprises a disk 604, a spindle motor 605 to spin the disk 604, the HSA 400, a VCM 603 and a housing 606 for receiving all the abovementioned components. The HSA 400 is driven by the VCM 603 mounted in the disk drive unit 600 to move and then causing a selective movement of the slider 601 at distal end of the HSA 400 from track to track over the surface of the disk 604, and realizing a data reading/writing operation.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A head stack assembly for a disk drive unit, comprising:
at least one drive arms, each of which has a mounting hole formed therein;
at least one head gimbal assemblies, each of which connecting with one of the at least one drive arms;
a fantail spacer having a mounting hole formed therein; and
a bearing assembly; wherein
the bearing assembly respectively extends through the mounting holes of the at least one drive arms and the fantail spacer and fastens them together; wherein each of the drive arms has at least one first positioning elements, and the fantail spacer has at least one second positioning elements each of which engaging with one of the first positioning elements.

2. The head stack assembly according to claim 1, wherein the first positioning elements and the second positioning elements are secured together by laser welding.

3. The head stack assembly according to claim 1, wherein the first positioning elements and the second positioning elements are secured together by adhesive bonding or clasping.

4. The head stack assembly according to claim 1, wherein the first positioning elements are positioning holes, the second positioning elements are positioning posts disposed on the fantail spacer, and the positioning posts extend through the respective positioning holes and are secured together.

5. The head stack assembly according to claim 1, wherein each of the drive arm has two first positioning elements thereon, the two first positioning elements being in a same line with the center of the mounting hole of the drive arm; and the second positioning elements of the fantail spacer has an amount adapted to that of the first positioning elements.

6. The head stack assembly according to claim 1, wherein the first positioning elements and the second positioning elements are made of metal material.

7. The head stack assembly according to claim 6, wherein the first positioning elements and the second positioning elements are made of stainless steel material.

8. The head stack assembly according to claim 4, wherein the positioning holes are of circle shape, and the positioning posts are of cylinder shape.

9. A disk drive unit, comprising:
a disk;
a spindle motor to spin the disk;
a head stack assembly; and
a voice coil motor to cause movement of the head stack assembly; wherein
the head stack assembly comprises:
at least one drive arm, each of which has a mounting hole formed thereon;
at least one head gimbal assembly, each of which connecting with one of the at least one drive arm;
a fantail spacer having a mounting hole; and
a bearing assembly; wherein
the bearing assembly respectively extends through the mounting holes of the at least one drive arm and the fantail spacer and fastens them together; wherein each of the drive arms has at least a first positioning elements, and the fantail spacer has at least one second positioning elements each of which engaging with one of the first positioning elements.

10. The disk drive unit according to claim 9, wherein the first positioning elements and the second positioning elements are secured together by laser welding.

11. The disk drive unit according to claim 9, wherein the first positioning elements and the second positioning elements are secured together by bonding or clasping.

12. The disk drive unit according to claim 9, wherein the first positioning elements are positioning holes, the second positioning elements are positioning posts disposed on the fantail spacer, and the positioning posts extend through the respective positioning holes and are secured together.

13. The disk drive unit according to claim 9, wherein each of the drive arm has two first positioning elements thereon, the two first positioning elements being in a same line with the center of the mounting hole of the drive arm; and the second positioning elements of the fantail spacer has an amount adapted to that of the first positioning elements.

14. The disk drive unit according to claim 12, wherein the positioning holes are of circle shape, and the positioning posts are of cylinder shape.

15. A manufacturing method of head stack assembly, comprising the steps of:
providing at least one drive arms, each of which having a mounting hole and at least a first positioning elements; at least one head gimbal assemblies; a fantail spacer having a mounting hole and at least one second positioning elements engaging with the at least one first positioning elements, respectively; and a bearing assembly;
assembling the at least one drive arms and the at least one head gimbal assemblies to form at least one head arm assemblies;
fastening the first and second positioning elements together such that the at least one head arm assemblies and the fantail spacer are fastened together; and
fastening the at least one head arm assemblies and fantail spacer together stably by extending the bearing assembly through the respective mounting holes of the at least one head arm assemblies and the fantail spacer.

16. The manufacturing method according to claim 15, wherein the first positioning elements and the second positioning elements are secured together by laser welding.

17. The manufacturing method according to claim 15, wherein the first positioning elements and the second positioning elements are secured together by bonding or clasping.

18. A manufacturing method of head stack assembly, comprising the steps of:
providing at least one drive arms, each of which having a mounting hole and at least a first positioning elements; at least one head gimbal assemblies, a fantail spacer having a mounting hole and at least one second positioning elements engaging with the at least one first positioning elements, respectively; and a bearing assembly;
assembling the at least one drive arms and the at least one head gimbal assemblies to form at least one head arm assemblies;
fastening the first and second positioning elements together such that the at least one head arm assemblies and the fantail spacer are fastened together;
testing slider performance of the at least one head gimbal assemblies; and
fastening the tested head arm assemblies and the fantail spacer together stably by extending the bearing assembly through the respective mounting holes of the at least one head arm assemblies and the fantail spacer.

19. The manufacturing method according to claim 18, wherein before testing slider performance of the head gimbal assemblies, the method further comprises a step of holding the at least one head arm assemblies and the fantail spacer using a fixture which extends through the mounting holes of the at least one head arm assemblies and the fantail spacer after they are secured together.
